(19) United States
(12) Patent Application Publication
(10) Pub. No.: US 2019/0322504 A1
(43) Pub. Date: Oct. 24, 2019

(54) Autonmous Vehicle Pickup and Delivery Device

(71) Applicant: Christopher Edward Raab., Levittown, PA (US)

(72) Inventor: Christopher Edward Raab., Levittown, PA (US)

(21) Appl. No.: 15/956,118

(22) Filed: Apr. 18, 2018

(51) Int. Cl. B66F 9/06; G05D 1/02; B66F 9/075; B66F 9/18; B25J 9/16; B25J 15/00; B25J 15/02; G06Q 10/08

(52) U.S. Cl. CPC B66F 9/063; G05D 1/028; B66F 9/0755; B66F 9/183; G05D 2201/0216; B25J 15/0095; B25J 15/026; G06Q 10/083; G05D 1/0272; B25J 9/161

(57) ABSTRACT

An apparatus for autonomous or driverless vehicles to perform pick-up and delivery of packages, parcels, or other cargo with minimal or no human intervention is disclosed. The apparatus at a minimum consists of an opening/closing mechanism for a cargo compartment (trunk, lockbox attached to the vehicle, vehicle cab, etc.), which can be accessed when an encoded electronic signal is received, and then an arm-like device that extends from the compartment to retrieve or drop off cargo activates as instructed by an appropriate signal.

### FIELD OF THE INVENTION

This invention pertains to the field of autonomous vehicles, and more specifically for their use as autonomous delivery vehicles.

### BACKGROUND OF THE INVENTION

This invention relates to the autonomous (driverless) vehicle industry, particularly the picking up and dropping off of packages, parcels, and other sorts of cargo without the need of a human driver or delivery person to do the physical lading of the cargo.

There is a need for such a device as driverless vehicles become prevalent on the road, in that such a device allows users to efficiently use their time while the vehicle does the mundane and time consuming tasks of picking up and dropping off cargo, parcels, packages, groceries, etc. One of the greatest problems in the logistics industry is to solve the “last mile problem”, or how to get from the centralized distribution warehouse to the end user most efficiently; up to this point, that problem has been solved by having a person manually drive the package on their delivery route, remove the package from their vehicle and place it on a porch or driveway, and do this repetitively for each parcel delivered. With the coming advent of autonomous vehicles, we would be able to dispense with the driver, except for the need to load and unload the delivery. There are other attempts to circumvent this problem, but they each raise other difficulties.

For example, U.S. Pat. No. 9,174,733 discloses a cargo drop system for unmanned aerial vehicles (UAVs), and likewise U.S. Pat. No. 9,928,749 which discloses a truck based UAV hive for deliveries; but with the expected boom in autonomous cars, and similar land vehicles, an invention as is described herein will better utilize resources that would otherwise be sitting idle.

On the other hand, U.S. Pat. No. 9,256,852 describes an autonomous truck where the recipient of the parcel must be present at the truck at the time a delivery is attempted in order to access the subsystem holding their delivery; this is very inconvenient for some people because they have to be able to get outside at the exact moment when the truck is ready to deliver the package.

The invention claimed herein avoids the shortcomings of these sorts of approaches by offering a solution that does not require a human to be available at either the loading or unloading points of the package.

### BRIEF DESCRIPTION OF THE DRAWINGS

FIG. 1. An overview of the most basic formulation of the apparatus as would be attached to a sedan.

FIG. 2. An overview of a possible iteration of the arm-like structure

### DETAILED DESCRIPTION

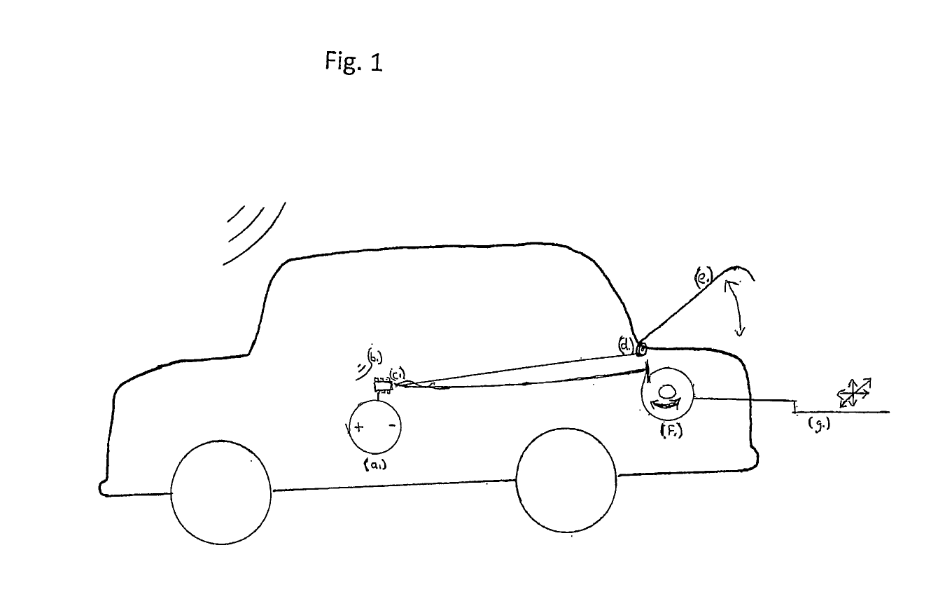

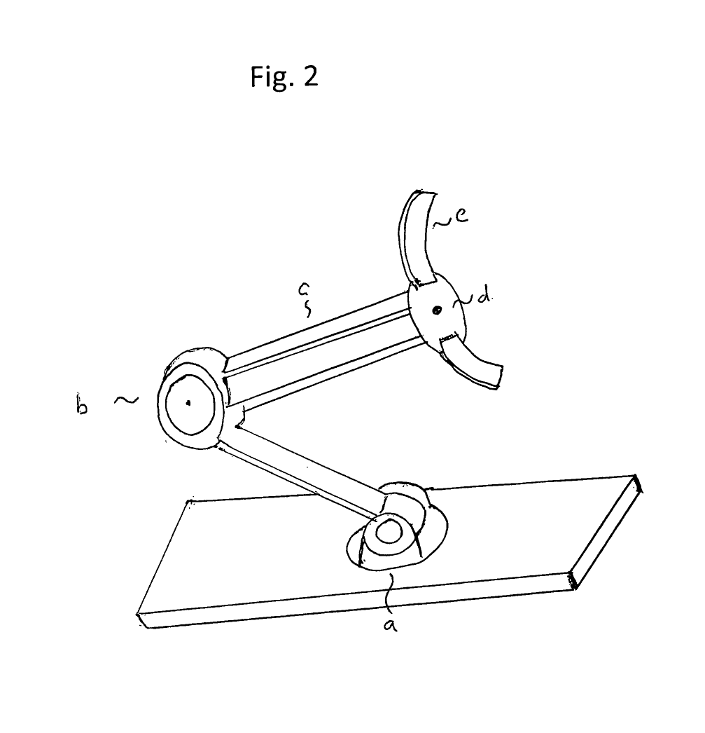

1. FIG. 1 illustrates the connection of the apparatus to the autonomous vehicle, where a power source (i.e. battery or similar)(a.) is connected to is a communication device consisting one or more sensors for receiving and transmitting an electronic signal (such as Bluetooth, NFC, wifi, cellular network, satellite, etc.) for communicating with the vehicle itself or directly with a centralized transportation hub that gives instructions (b.), which is connected to a microprocessor (c.) which, when given the correct encoded signal, activates one or more motors, actuators, hydraulic or pneumatic pistons (and the electronics necessary for the operation of same)(d.) to unlock and/or open a cargo compartment on a vehicle (such as a trunk, cab of the vehicle, a special locking container, etc.) (e.) where the microprocessor also activates a separate one or more motors, actuators, hydraulic or pneumatic pistons (f.) connected to at least one arm-like device, with or without a robotic claw for lifting and gripping (g.) that moves inward and outward from the cargo containing compartment to pick up or drop off cargo as appropriate, place cargo within or take cargo out of the cargo containing compartment, which is further connected to a series of sensors on or near the arm-mechanism which sensors transmit the size, shape, location or other pertinent information about the physical characteristics of the package or item to be picked up, where the sensors transmit such information to a microprocessor which then calculates and coordinates the movements necessary for the arm-like structure and any gripping mechanisms (i.e. claw or robotic hand) to pick up the package or box, and then the microprocessor sends the necessary signals to effectuate the movement of the arm-like structure and any gripping mechanism to the package to pick it up and place where it is to be placed either in the vehicle, in a compartment connected to the vehicle or at the package's final destination, where when such action is complete the sensors sends an encoded signal to inform the microprocessor which then informs the vehicle or centralized transportation hub of the completion of the task.
2. FIG. 2 illustrates a possible embodiment of the robotic arm-mechanism mentioned above, where a series of motors, gears and actuators form an articulates base (a.) that is attached to the autonomous vehicle, such that the base allows for movement sufficient to move the first bone-like structure of the arm-apparatus in a circular and/or pivotal motion, so that the first bone-like structure connects to an elbow-like apparatus which includes the motors, actuators, gearing, hydraulics, etc., necessary to become a pivot point for the larger arm-like structure (b.), which allows the second bone-like structure of the arm-apparatus (c.), which further connects to a hand-like apparatus (d.) that can tighten or loosen the “fingers” of the hand-like apparatus by way of a series of motors, actuators, gears, hydraulics, pneumatic pistons, etc., such that a parcel or other item can be picked up and put down without the need for a human loader, which further contains a sensor or sensors that use radio waves to determine distance, size, shape, etc., of the parcel to be lifted.

### SUMMARY OF THE INVENTION

The present invention builds on the nascent prior art in the driverless vehicle industry by giving the driverless vehicle a way to perform functions that heretofore required a person present to perform. For example, under current formulations, if a driverless vehicle is being used to pick up a package from a parcel delivery warehouse, post office, store, or some other such place, a person must be present with the vehicle to open the doors of the vehicle, load the cargo, and then close the doors. In the most basic formulation, this invention allows the vehicle user to send the vehicle on such a pick-up errand without having to be present. In its most basic form, when the autonomous vehicle arrives to the pick-up/drop-off location, the apparatus receives an electronic signal that instructs it to open an access door (trunk, cargo compartment, car door, etc.), and then, depending on the request, uses an extending arm-like device to deliver the cargo, or to pick up the cargo. Upon completion of the signaled task, the arm-like structure returns to the vehicle and closes the compartment door, allowing the vehicle to continue on its journey.

What is claimed:

1. A robotic arm or arms connected to an autonomous vehicle (car, truck, van, SUV, or similar, or to a cargo container attached to such):
consisting of a communication device (whether wired or wireless) connected to an autonomous or driverless vehicle or to a centralized transportation HUB, connection to a power source, one or more sensors for receiving and transmitting an electronic signal (such as Bluetooth, NFC, wifi, cellular network, satellite, etc.);
which in turn is connected to a microprocessor;
which, when given the correct encoded signal, activates a one or more motors, actuators, hydraulic or pneumatic pistons (and the electronics necessary for the operation of same) to unlock and/or open a cargo compartment on a vehicle (such as a trunk, cab of the vehicle, a special locking container, etc.) and the microprocessor also activates a separate one or more motors, actuators, hydraulic or pneumatic pistons connected to at least one arm-like device, with or without a robotic claw for lifting and gripping that moves inward and outward from the cargo containing compartment to pick up or drop off cargo as appropriate, which is further connected to a series of sensors on the arm-mechanism that transmit the size shape and location of the package or item to be picked up, where the sensors transmit such information to a microprocessor which then calculates and coordinates the movements necessary for the arm-like structure and any gripping mechanisms (i.e. claw or robotic hand) to pick up the package or box, and then the microprocessor sends the necessary signals to effectuate the movement of the arm-like structure and any gripping mechanism to the package to pick it up and place where it is to be placed either in the vehicle, in a compartment connected to the vehicle or at the item's final destination, where when such action is complete the sensors sends an encoded signal to inform the microprocessor which then informs the vehicle of the completion of the task.

2. An apparatus such as described in claim 1 that includes an additional electronic communication device for communicating with other electronic holding devices where interaction with them is necessary to retrieve or drop off a package or other delivery.

3. An apparatus such as described in claim 1 that, upon instruction and authorization of the user, can transmit electronic payments via wireless signal.

4. An autonomous vehicle (car, truck, SUV, or cargo pod(s) that is attached to the vehicle) that has a device such as described in claim 1 attached to it.
